(19) United States
(12) Patent Application Publication
(10) Pub. No.: US 2025/0136253 A1
(43) Pub. Date: May 1, 2025

(54) MOORING DEVICE AND METHOD

(71) Applicant: ENI S.P.A., Roma (RM) (IT)

(72) Inventors: Luca GAROFALO, San Donato Milanese (MI) (IT); Domenica PIZZIRUSSO, San Donato Milanese (MI) (IT); Osvaldo Maria DI PIETRO, San Donato Milanese (MI) (IT)

(21) Appl. No.: 18/686,582

(22) PCT Filed: Aug. 17, 2022
(86) PCT No.: PCT/IB2022/057700

§ 371 Date: Feb. 26, 2024

(30) Foreign Application Priority Data
Aug. 27, 2021 (IT) 102021000022421

(51) Int. Cl. B63B 35/44; F03B 13/14

(52) U.S. Cl. CPC B63B 35/44; F03B 13/14; B63B 2035/4466; B63B 2221/22

(57) ABSTRACT

A mooring device for a wave energy conversion apparatus includes a three-dimensional beam structure which houses the wave energy conversion apparatus and which includes two elements for rotoidal coupling to the energy conversion apparatus by wave motion spaced apart and defining an axis of rotation for the same apparatus. The device also includes an anchoring component fixed to the three-dimensional beam structure.

### CROSS-REFERENCE TO RELATED APPLICATIONS

This application is a 35 U.S.C. § 371 National Stage patent application of PCT/IB2022/057700, filed on 17 Aug. 2022, which claims the benefit of Italian patent application 102021000022421, filed on 27 Aug. 2021, the disclosures of which are incorporated herein by reference in their entirety.

### TECHNICAL FIELD

The present disclosure relates to a mooring device for a wave energy conversion apparatus.

The disclosure is suitable for installation on vessels in general and, specifically, on WEC (Wave Energy Converter) systems or floating systems equipped with mooring lines.

### BACKGROUND

The recovery and conversion of wave energy has long been the subject of many investigations in order to identify efficient and reliable technological solutions. The characteristics of the wave motion configure it as a system with high variability of conditions such as the wave frequency, the wave height, the presence of prevailing currents or a multiplicity of currents; it is therefore evident that the effective exploitation of the energy contained in the waves represents a challenge that is not easy to solve and which must be measured with conditions that are difficult to predict and then impacting the construction of systems that can offer good efficiency in different operating conditions.

Many solutions have been developed to recover energy from waves; some of these are based on the concept of using one or more floating buoys connected by cables to move hydraulic or electric generators; other solutions exploit the gyroscopic effect to transform the forces acting on floating hulls into electrical energy through electrical or hydraulic power sockets.

The solutions known to date for energy recovery from wave motion must all be compared with a low energy conversion efficiency also linked to the interaction of mooring systems with wave energy conversion equipment. Whilst, on the one hand, it is necessary to hold back and anchor the energy conversion in order to counteract the sea currents that would tend to drag them, on the other hand, the mooring systems partially limit the freedom of movement of these devices, thus reducing their effectiveness with respect to the wave energy transmitted to them.

The mooring systems known to date have been created with the aim of keeping a vessel stationary in a certain position with, at most, the possibility of small movements around a certain radius. Consequently, traditional mooring systems have the effect of significantly dampening the oscillations of the vessel connected to them which, in the case of a wave energy conversion apparatus, is reflected in a drastic decrease in the ability to convert energy.

### SUMMARY

The purpose of the present disclosure is to provide a mooring device, the structure and connection of which to an apparatus for the conversion of energy from wave motion favour the freedom of oscillation of the apparatus itself, thus increasing its efficiency and improving its operation according to prevailing directions of oscillation. According to the present disclosure, a mooring device has been created for a wave energy conversion apparatus comprising:
a three-dimensional beam structure that houses the wave energy conversion apparatus and which includes two rotational coupling elements linked to the wave energy conversion apparatus that are spaced apart, defining a rotation axis (A) for the same apparatus; the rotoidal coupling elements allowing the rotation of the apparatus with respect to axis A;
mooring means, fixed to the three-dimensional structure, configured for the connection of mooring lines.

The present disclosure also relates to a method for mooring a wave energy conversion apparatus as described below.

### BRIEF DESCRIPTION OF THE DRAWINGS

The characteristics and advantages of the present disclosure will appear clear from the description which follows from its non-limiting examples of implementation with reference to the figures of the appended drawings, wherein:

FIG. 1 is a schematic view of the mooring device for a wave energy conversion apparatus;

FIG. 2 schematically represents a detail of the rotoidal coupling of the mooring device;

FIG. 3 is a schematic view of the mooring device for a wave energy conversion apparatus in a preferred embodiment thereof;

FIG. 4 is a schematic view of the mooring device for a wave energy conversion apparatus of FIG. 3 comprising a rotating joint for the attachment of the anchor lines;

FIG. 5 is a schematic view of the mooring device for a wave energy conversion apparatus in a further preferred embodiment thereof;

FIG. 6 is a schematic view of the mooring device for a wave energy conversion apparatus of FIG. 5 comprising a rotating joint for the attachment of the mooring lines; and

FIGS. 7 and 8 schematically show the positioning of the mooring device with respect to an apparatus for converting energy from wave motion.

### DETAILED DESCRIPTION OF THE DRAWINGS

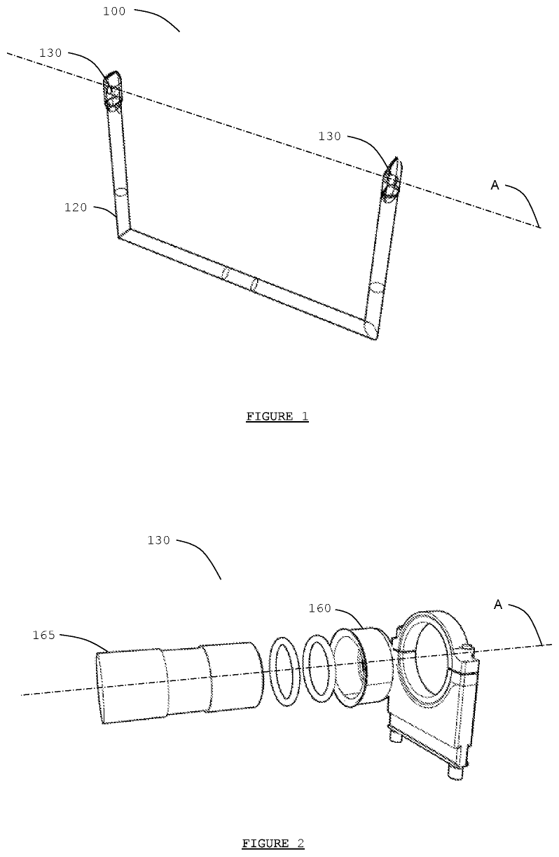

With reference to FIG. 1, the mooring device (100) covered by the disclosure comprises a structure (120) of beams which develops three-dimensionally, accommodating an apparatus (110) for converting energy from wave motion. The three-dimensional structure (120) is designed to function as a transition element between the hull of the apparatus (110) and the mooring lines (150). The mooring device (100) is coupled to the apparatus (110) for converting energy from wave motion by means of connections which make the rotation of the hull of the apparatus (110) around an axis (A) through rotoidal coupling elements (130). In this way, the wave energy conversion apparatus (110) can freely rotate around the axis (A) without being limited by the presence of mooring lines (150) directly connected thereto. The configuration of the three-dimensional structure (120), obtained by means of beams, allows for the surface exposed to sea currents to be reduced and, consequently, for the impact of the resulting forces acting on the structure (120) itself to be reduced. The anchoring means, which allows the connection of the mooring lines (150), are fixed on the three-dimensional structure (120), ensuring maximum freedom of rotation for the apparatus (110). In this way, the main cause of the reduction of the oscillation of the wave energy conversion apparatus (110) turns out to be the friction of the toroidal coupling elements (130). The anchoring means fixed to the three-dimensional structure (120) can comprise a rotating joint (145) to which the mooring lines (150) are connected. The joint (145) is known in itself in the state of the art and, in the offshore technical sector, it is normally identified as “swivel”.

In a preferred embodiment of the disclosure, as shown in FIG. 2, the rotoidal coupling elements (130) are pins (165) with longitudinal axis coinciding with the axis (A), said pins (165) being equipped with bearings (160). This further reduces the friction produced by the toroidal coupling elements (130) during the oscillation of the wave motion energy conversion apparatus (110) around the axis (A).

In a further preferred configuration of the disclosure, the bearings (160), with which the pins (165) are equipped, are sliding and made of polymeric material resistant to the marine environment. In this way, improved reliability of the rotation kinematics is guaranteed, which is adequate for the conditions of humidity and the presence of highly corrosive chlorides in the marine environment.

The three-dimensional beam structure (120) is an excellent basis for the realization of the inventive concept described above which is made further effective by creating a simplified geometry described below.

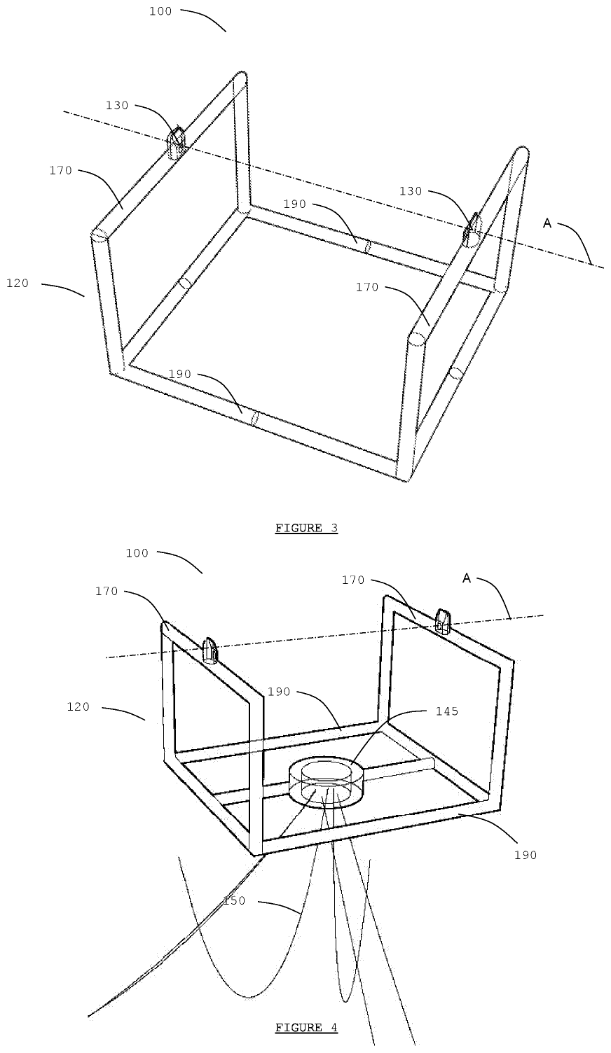

According to a preferred embodiment of the disclosure as described above, with reference to FIG. 3, the three-dimensional beam structure (120) comprises two lateral planar beams (170) parallel to each other and spaced apart by longitudinal members (190) of predefined length, each lateral beam (170) comprising one of the rotoidal coupling elements (130). In this way, a three-dimensional structure (120) can be created with modular characteristics wherein the lateral beams (170) and the longitudinal members (190) can be easily designed and adapted to different hull dimensions. The configuration with lateral beams (170) planar parallel to each other creates a configuration of simple construction which is also well suited to offshore fabrication. The modification of the length of the longitudinal members (190) enables the three-dimensional structure (120) to be easily adapted different types of hulls. With reference to FIG. 4, in this preferred embodiment of the disclosure, the anchoring means fixed to the three-dimensional structure (120) can comprise a rotating joint (145) to which the mooring lines (150) are connected. The joint (145) is known in itself in the state of the art and, in the offshore technical sector, it is normally identified as “swivel”.

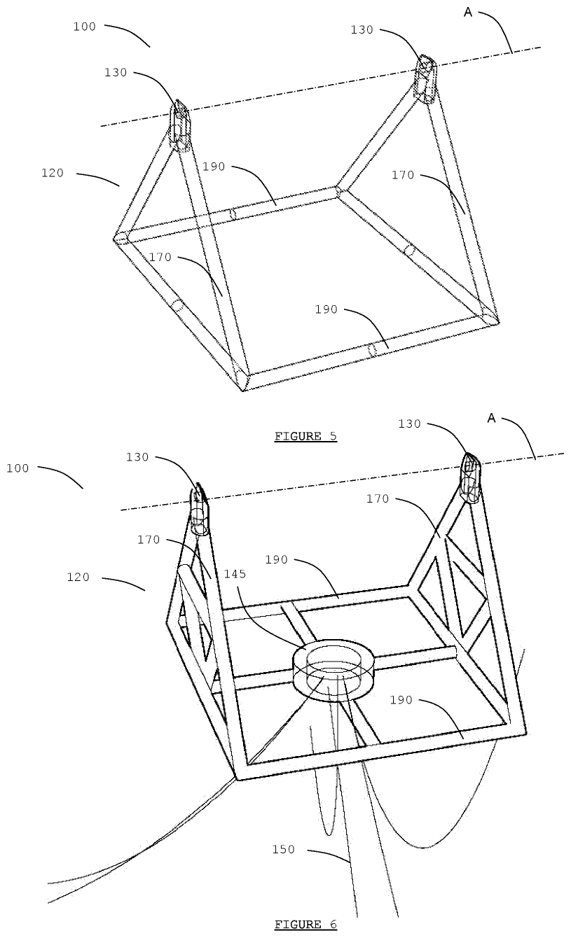

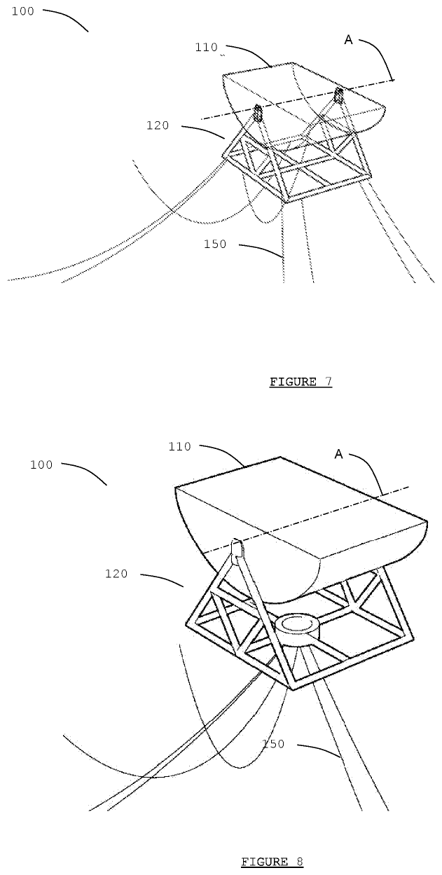

In a further preferred embodiment of the disclosure as previously described, with reference to FIG. 5, each lateral truss (170) has a triangular shape wherein it is applied to a vertex of each lateral truss (170). The triangular geometry of the lateral beams 170 represents the simplest and structurally adequate solution to support the loads deriving from the wave motion discharged on the hull of the apparatus 110 for converting energy from wave motion. The lateral beams (170) can be further reinforced by means of elements positioned inside the triangles. The longitudinal members (190) can also be further stiffened by means of reinforcement structures which connect the longitudinal members (190) together to form lattices.

The three-dimensional structure (120), as used in any of the preferred embodiments described, is preferably made with tubular elements of suitable diameter and thickness to support the loads resulting from the interaction of the wave motion with the hull of the energy conversion apparatus (110).

With reference to FIG. 6, in this preferred embodiment of the disclosure, the anchoring means fixed to the three-dimensional structure (120) can comprise a rotating joint (145) to which the mooring lines (150) are connected. The joint (145) is known in itself in the state of the art and, in the offshore technical sector, it is normally identified as “swivel”.

The present disclosure also relates to a method for mooring an apparatus (110) for converting energy from wave motion comprising the following steps:
providing an apparatus (110) for converting energy from wave motion;
connecting the wave motion energy conversion apparatus (110) to the mooring device (100) according to any of the preferred embodiments described so that the rotation axis (A) passes through the centre of gravity of the apparatus (100);
binding the mooring device (100) to the seabed by mooring lines (150).

By means of the method covered by the present disclosure, the apparatus (110) for converting energy from wave motion to the seabed can be bound so as to leave it ample freedom of movement and to maximise the amount of rotation possible around the axis (A). In this way, the energy conversion is maximised and, consequently, the efficiency of the apparatus (110) is also maximised.

The device (100) covered by the present disclosure thus conceived is, in any case, susceptible to a number of changes and variations, all of which are within the scope of the same inventive concept; furthermore, all the details can be replaced by technically equivalent elements. In practice, the materials used may be any according to the technical requirements.

The scope of protection of the disclosure is therefore defined by the accompanying claims.

1. A mooring device for a wave energy conversion apparatus, the mooring device comprising:
a three-dimensional beam structure which houses the wave energy conversion apparatus and which comprises two elements for rotational coupling to the wave energy conversion apparatus which are spaced apart from each other, defining a rotation axis for the same apparatus; the rotoidal coupling elements allowing for the rotation of the apparatus with respect to the axis; and
anchoring means, fixed to the three-dimensional beam structure, configured for the connection of mooring lines.

2. The mooring device according to claim 1, wherein rotoidal coupling elements are pins with longitudinal axis coinciding with the axis, said pins being equipped with bearings.

3. The mooring device according to claim 2, wherein the bearings are sliding in polymeric material resistant to the marine environment.

4. The mooring device according to claim 1, wherein the three-dimensional beam structure comprises two lateral planar beams parallel to each other and spaced apart by longitudinal members of predefined length, each beam lateral comprising one of the rotoidal coupling elements.

5. The mooring device according to claim 4, wherein each lateral truss has a triangular shape wherein the rotoidal coupling element is applied to a vertex of each lateral truss.

6. The mooring device according to claim 1, wherein the anchoring means comprise a rotating joint to which the mooring lines are connected.

7. A method for mooring a wave energy conversion apparatus, the method including the following steps:
providing an apparatus for converting energy from wave motion;
connecting the wave energy conversion apparatus to the mooring device according to claim 1 whereby the rotation axis passes through the centre of gravity of the apparatus; and
binding the mooring device to the seabed by mooring lines.
